(19) United States
(12) Patent Application Publication
(10) Pub. No.: US 2026/0326088 A1
(43) Pub. Date: Oct. 22, 2026

(54) EXHAUST GAS PURIFICATION CATALYST

(71) Applicants: TOYOTA JIDOSHA KABUSHIKI KAISHA, Toyota-shi (JP); CATALER CORPORATION, Kakegawa-shi (JP)

(72) Inventors: Takahiro NISHIO, Nagoya-shi (JP); Nobuyuki TAKAGI, Toyota-shi (JP); Hiroyuki ISHIKAWA, Anjou-shi (JP); Naoto FUJITA, Hamamatsu-shi (JP); Yosuke TODA, Iwata-shi (JP); Mizuho MORI, Hamamatsu-shi (JP); Yuri NISHIMURA, Fukuroi-shi (JP)

(73) Assignees: TOYOTA JIDOSHA KABUSHIKI KAISHA, Toyota-shi (JP); CATALER CORPORATION, Kakegawa-shi (JP)

(21) Appl. No.: 19/637,036

(22) Filed: Apr. 2, 2026

(30) Foreign Application Priority Data
Apr. 17, 2025 (JP) 2025-068145

(51) Int. Cl. B01J 23/63; B01D 53/94; B01J 35/00; B01J 37/02; F01N 3/28

(52) U.S. Cl. CPC B01J 23/63; B01D 53/9468; B01D 53/9472; B01J 35/19; B01J 37/0244; F01N 3/2803; B01D 2255/1021; B01D 2255/1023; B01D 2255/1025; B01D 2255/2061; B01D 2255/2063; B01D 2255/2065; B01D 2255/20715; B01D 2255/2092; B01D 2255/9022; B01D 2255/9032; B01D 2255/908; B01D 2257/404; B01D 2258/01; F01N 2370/02

(57) ABSTRACT

The exhaust gas purification catalyst includes two catalysts with a first catalyst and a second catalyst combined, the second catalyst being arranged rearward of the first catalyst with respect to an exhaust gas flow direction. The second catalyst includes an Fr-side coat layer in a front stage with respect to the exhaust gas flow direction and an Rr-side coat layer in a rear stage. A total surface area of the OSC material contained in the first catalyst (SA_{first catalyst}) and a total surface area of the OSC material contained in the second catalyst (SA_{second catalyst}) satisfy SA_{first catalyst}>SA_{second catalyst}, and a total surface area of the OSC material contained in the Fr-side coat layer (SA_{Fr-side coat layer}) and a total surface area of the OSC material contained in the Rr-side coat layer (SA_{Rr-side coat layer}) satisfy SA_{Fr-side coat layer}>SA_{Rr-side coat layer}.

### CROSS REFERENCE TO RELATED APPLICATIONS

The present application claims priority from Japanese patent application JP 2025-068145 filed on Apr. 17, 2025, the entire content of which is hereby incorporated by reference into this application.

### BACKGROUND

### Technical Field

The present disclosure relates to an exhaust gas purification catalyst. In more detail, it relates to an exhaust gas purification catalyst including two catalysts with a first catalyst and a second catalyst combined.

### Background Art

Exhaust gases discharged from automotive and other internal combustion engines contain harmful gases, such as carbon monoxide (CO), nitrogen oxides (NOx), and unburned hydrocarbons (HC). Exhaust gas purification catalysts that decompose such harmful gases are referred to as three-way catalysts and generally include a catalyst coat layer formed by wash-coating a slurry containing noble metal particles having catalytic activity and a cocatalyst having an Oxygen Storage Capacity (OSC) on a monolith substrate with a honeycomb shape made of cordierite or the like.

Various attempts have been made to improve the purification efficiency of exhaust gas purification catalysts. For example, JP 2004-305954 A discloses an exhaust gas purification catalyst that includes a porous carrier, a noble metal supported on the porous carrier, and a NOx storage material selected from an alkali metal, an alkaline-earth metal, and La and supported on the porous carrier. In the exhaust gas purification catalyst, an oxygen storage/release material selected from oxides of rare earth elements excluding La and oxides of transition metals is contained in a larger amount on an exhaust gas upstream side than on an exhaust gas downstream side.

JP 2012-86199 A discloses an exhaust gas purification catalyst including a first-stage catalyst at a position on an upstream side and a second-stage catalyst at a position on a downstream side in an exhaust flowing direction, which are provided on a substrate, respectively. The first-stage catalyst and the second-stage catalyst each include an OSC material. A proportion of an amount of the OSC material, on which a noble metal is not supported, (hereinafter abbreviated as OSC material (N)), and that is included in the second-stage catalyst with respect to a combined amount of the OSC material (N) that is included in the first-stage catalyst and the second-stage catalyst is in a range of from 0 mass % to 50 mass %.

While exhaust gas regulations are becoming stricter, a reduction in the amount of noble metals used in exhaust gas catalysts is required from the viewpoint of resource risk. In recent years, in addition to the tightening of regulatory values, exhaust systems corresponding to various driving modes are required. For example, when driving at a constant speed on a highway, the driver will always press the accelerator pedal steadily. As a result, since a state where the fuel is constantly injected continues, the performance of a catalyst may deteriorate due to the accumulation of unburned components of the fuel in the catalyst, compared with catalytic purification that involves changing the speed. Taking such a case into consideration, if the exhaust gas regulations are to be satisfied, a larger amount of noble metals will be necessary than before, which may lead to a surge in component prices.

Therefore, in order to solve the problem, one aspect of the present disclosure relates to providing an exhaust gas purification catalyst that allows ensuring excellent purification performance even after durability testing.

### SUMMARY

In an exhaust gas purification catalyst including two catalysts with a first catalyst and a second catalyst combined, when a state where a fuel is constantly injected continues, an Oxygen Storage Capacity (OSC) material that controls the oxygen concentration tends to be the starting point of the adsorption for accumulation of unburned fuel components, and further, the catalyst present at a rear stage of an exhaust system, which has a reduced oxygen concentration, is more susceptible to this effect.

The inventors examined various means to solve the problem, and found that the following exhaust gas purification catalyst allows ensuring excellent purification performance even after durability testing. The exhaust gas purification catalyst includes two catalysts with a first catalyst and a second catalyst combined. The second catalyst is arranged rearward of the first catalyst with respect to an exhaust gas flow direction. In the exhaust gas purification catalyst, the second catalyst has a configuration including an Fr-side coat layer in a front stage with respect to the exhaust gas flow direction and an Rr-side coat layer in a rear stage with respect to the exhaust gas flow direction. Further, the first catalyst, as well as the Fr-side coat layer and the Rr-side coat layer in the second catalyst, have configurations containing an OSC material. The order of a total surface area of the OSC material is that the first catalyst>the second catalyst, and the Fr-side coat layer>the Rr-side coat layer. Thus, the inventors completed one aspect of the present disclosure.

That is, the gist of one aspect of the present disclosure is as follows.

(1) An exhaust gas purification catalyst comprising
two catalysts with a first catalyst and a second catalyst combined, the second catalyst being arranged rearward of the first catalyst with respect to an exhaust gas flow direction,
wherein the second catalyst includes an Fr-side coat layer in a front stage and an Rr-side coat layer in a rear stage with respect to the exhaust gas flow direction,
wherein the first catalyst, the Fr-side coat layer, and the Rr-side coat layer contain an OSC material,
wherein a total surface area of the OSC material contained in the first catalyst (SA_{first catalyst}) and a total surface area of the OSC material contained in the second catalyst (SA_{second catalyst}) satisfy
SA_{first catalyst}>SA_{second catalyst}, and
wherein a total surface area of the OSC material contained in the Fr-side coat layer (SA_{Fr-side coat layer}) and a total surface area of the OSC material contained in the Rr-side coat layer (SA_{Rr-side coat layer}) satisfy
SA_{Fr-side coat layer}>SA_{Rr-side coat layer}.

(2) The exhaust gas purification catalyst according to (1), wherein
{SA_{Fr-side coat layer}/(SA_{first catalyst}+SA_{Fr-side coat layer})}×100 is 50 or less, and {SA_{Rr-side coat layer}/(SA_{Fr-side coat layer}+SA_{Rr-side coat layer})}×100 is 50 or less.

(3) The exhaust gas purification catalyst according to (1) or (2), wherein the Fr-side coat layer contains Pt.

(4) The exhaust gas purification catalyst according to any one of (1) to (3), wherein the Rr-side coat layer contains Rh.

With one aspect of the present disclosure, an exhaust gas purification catalyst that allows ensuring excellent purification performance even after durability testing is provided.

### BRIEF DESCRIPTION OF THE DRAWINGS

FIG. 1 is a schematic diagram illustrating an exhaust gas purification catalyst of one aspect of the present disclosure; and

FIG. 2 is a graph illustrating the relationship between {SA_{Fr-side coat layer}/(SA_{frst catalyst}+SA_{Fr-side coat layer})}×100 and {SA_{Rr-side coat layer}/(SA_{Fr-side coat layer}+SA_{Rr-side coat layer})}×100 in exhaust gas purification catalysts of examples and comparative examples. The black circles indicate examples, and the crosses indicate comparative examples.

### DETAILED DESCRIPTION

The following describes preferred embodiments of one aspect of the present disclosure in detail.

In the description, features of one aspect of the present disclosure will be described with reference to the drawings, as necessary. In the drawings, dimensions and shapes of respective components are exaggerated for clarification, and actual dimensions and shapes are not accurately illustrated. Accordingly, the technical scope of one aspect of the present disclosure is not limited to the dimensions or the shapes of respective components illustrated in the drawings. Note that one aspect of the present disclosure is not limited to the embodiments below, and can be performed in various configurations where changes, improvements, and the like which a person skilled in the art can make are given without departing from the gist of one aspect of the present disclosure.

### [Exhaust Gas Purification Catalyst]

An exhaust gas purification catalyst of the present disclosure includes two catalysts with a first catalyst and a second catalyst combined. The second catalyst is arranged rearward of the first catalyst with respect to an exhaust gas flow direction.

The first catalyst and the second catalyst are different units and housed in separate housings. The first catalyst and the second catalyst may be connected by a connection means, such as a pipe or a plug. The first catalyst is arranged upstream with respect to the exhaust gas flow direction, that is, an exhaust gas inflow side, for example, directly under the engine. The second catalyst is arranged downstream of the first catalyst with respect to the exhaust gas flow direction, that is, an exhaust gas outflow side, for example, under the bed.

The distance between the first catalyst and the second catalyst is not limited, but is usually in a range of 1 cm or more and 200 cm or less, and in a range of 5 cm or more and 50 cm or less in one embodiment.

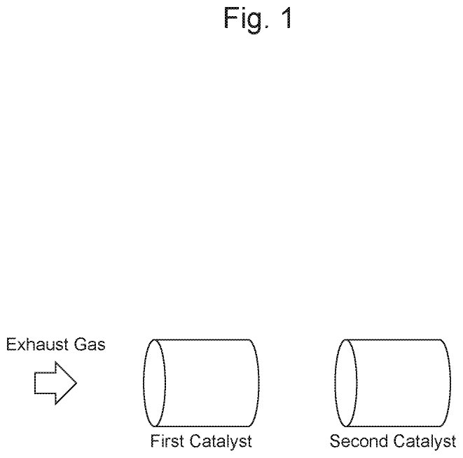

FIG. 1 illustrates the exhaust gas purification catalyst of one aspect of the present disclosure. With reference to FIG. 1, the exhaust gas purification catalyst of one aspect of the present disclosure includes two catalysts with the first catalyst and the second catalyst combined. The second catalyst is arranged rearward of the first catalyst with respect to the exhaust gas flow direction.

In one aspect of the present disclosure, the second catalyst includes an Fr-side coat layer in a front stage and an Rr-side coat layer in a rear stage with respect to the exhaust gas flow direction. Furthermore, the first catalyst, the Fr-side coat layer, and the Rr-side coat layer contain an OSC material. The OSC material will be described in detail below. In one aspect of the present disclosure, a total surface area of the OSC material contained in the first catalyst (SA_{first catalyst}) and a total surface area of the OSC material contained in the second catalyst (SA_{second catalyst}) satisfy the relationship of SA_{first catalyst}>SA_{second catalyst}. Further, a total surface area of the OSC material contained in the Fr-side coat layer (SA_{Fr-side coat layer}) and a total surface area of the OSC material contained in the Rr-side coat layer (SA_{Rr-side coat layer}) satisfy the relationship of SA_{Fr-side coat layer}>SA_{Rr-side coat layer}.

In one aspect of the present disclosure, by specifying the relationships of the total surface areas of the OSC material contained in the respective catalysts and layers as described above, in the resulting exhaust gas purification catalyst, the accumulation of unburned fuel components in the exhaust gas purification catalyst, especially in the second catalyst, can be suppressed, and excellent purification performance can be ensured even after durability testing.

In one aspect of the present disclosure, {SA_{Fr-side coat layer}/(SA_{first catalyst}+SA_{Fr-side coat layer})}×100 is usually 50 or less, and 40 or less in one embodiment. The lower limit value of {SA_{Fr-side coat layer}/(SA_{first catalyst}+SA_{Fr-side coat layer})}×100 is not limited, but is usually 1 or more, and 10 or more in one embodiment. In one aspect of the present disclosure, {SA_{Rr-side coat layer}/(SA_{Fr-side coat layer}+SA_{Rr-side coat layer})}×100 is usually 50 or less, and 45 or less in one embodiment. The lower limit value of {SA_{Rr-side coat layer}/(SA_{Fr-side coat layer}+SA_{Rr-side coat layer})}×100 is not limited, but is usually 1 or more, and 10 or more in one embodiment.

In one aspect of the present disclosure, by specifying {SA_{Fr-side coat layer}/(SA_{first catalyst}+SA_{Fr-side coat layer})}×100 and {SA_{Rr-side coat layer}/(SA_{Fr-side coat layer}+SA_{Rr-side coat layer})}×100 as described above, in the resulting exhaust gas purification catalyst, more excellent purification performance can be ensured even after durability testing.

In one aspect of the present disclosure, the SA_{first catalyst} is not limited as long as the relationships are satisfied. However, the SA_{first catalyst} is usually in a range of 2000 m² or more and 10000 m² or less per first catalyst, and in a range of 3000 m² or more and 8000 m² or less per first catalyst in one embodiment.

In one aspect of the present disclosure, the SA_{second catalyst} is not limited as long as the relationships are satisfied. However, the SA_{second catalyst} is usually in a range of 1500 m² or more and 9000 m² or less per second catalyst, and in a range of 1800 m² or more and 7000 m² or less per second catalyst in one embodiment.

In one aspect of the present disclosure, the SA_{Fr-side coat layer} is not limited as long as the relationships are satisfied. However, the SA_{Fr-side coat layer} is usually in a range of 1000 m² or more and 5000 m² or less per Fr-side coat layer, and in a range of 1000 m² or more and 4000 m² or less per Fr-side coat layer in one embodiment.

In one aspect of the present disclosure, the SA_{Rr-side coat layer} is not limited as long as the relationships are satisfied. However, the SA_{Rr-side coat layer is} usually in a range of 500 m² or more and 4000 m² or less per Rr-side coat layer, and in a range of 800 m² or more and 3000 m² or less per Rr-side coat layer in one embodiment.

In one aspect of the present disclosure, by specifying the total surface areas of the OSC material contained in the respective catalysts and layers as described above, in the resulting exhaust gas purification catalyst, excellent purification performance can be ensured even after durability testing.

In one aspect of the present disclosure, the volume of the first catalyst is not limited as long as the total surface areas of the OSC material contained in the respective catalysts and layers are specified as described above. However, the volume of the first catalyst is usually in a range of 0.5 L or more and 2.5 L or less, and in a range of 0.7 L or more and 1.5 L or less in one embodiment. In one aspect of the present disclosure, the volume of the second catalyst is not limited as long as the total surface areas of the OSC material contained in the respective catalysts and layers are specified as described above. However, the volume of the second catalyst is usually in a range of 0.5 L or more and 2.5 L or less, and in a range of 1.0 L or more and 2.0 L or less in one embodiment.

In one aspect of the present disclosure, the volume ratio of the first catalyst to the second catalyst (first catalyst/second catalyst) is not limited as long as the total surface areas of the OSC material contained in the respective catalysts and layers are specified as described above. However, the volume ratio of the first catalyst to the second catalyst (first catalyst/second catalyst) is usually in a range of 1.0 or more and 4.0 or less, in a range of 1.0 or more and 3.0 or less in one embodiment, and in a range of 1.0 or more and 2.0 or less in one embodiment.

In one aspect of the present disclosure, by specifying the volumes of the first catalyst and the second catalyst and/or the volume ratio of the first catalyst to the second catalyst as described above, it is easier to specify the relationships of the total surface areas of the OSC material contained in the respective catalysts and layers as described above, and in the resulting exhaust gas purification catalyst, excellent purification performance can be ensured even after durability testing.

### (Configuration of Each Catalyst)

The first catalyst includes a substrate and one or two or more catalyst coat layers formed on the surface of the substrate. The second catalyst includes a substrate and at least two layers, that is, catalyst coat layers of the Fr-side coat layer and the Rr-side coat layer, formed on the surface of the substrate.

### (Substrate)

In the exhaust gas purification catalyst of the present disclosure, a known substrate having a honeycomb shape can be used as a substrate in the first catalyst or the second catalyst. Specifically, a honeycomb-shaped monolith substrate (such as a honeycomb filter or a high-density honeycomb) or the like is adopted in some embodiments. In addition, the material of such a substrate is not particularly limited. Substrates made of ceramics, such as cordierite, silicon carbide, silica, alumina, and mullite, and substrates made of metals, such as stainless steel including chromium and aluminum, are adopted in some embodiments. Among these, from the viewpoint of cost, cordierite may be adopted.

The porosity of the substrate is not limited, but is usually in a range of 20% or more and 75% or less, and in a range of 30% or more and 70% or less in one embodiment.

### (Catalyst Coat Layer of First Catalyst)

The catalyst coat layer of the first catalyst is formed on the surface of the substrate and composed of one or two or more layers, that is, one, two, three, or four or more layers. In addition, the catalyst coat layer of the first catalyst does not necessarily have to be uniform across the entire substrate of the exhaust gas purification catalyst, and for each part of the substrate, it may have different compositions for each zone, for example, on an upstream side and a downstream side with respect to the exhaust gas flow direction. The different compositions mean, for example, that the components that constitute catalyst particles described later are different.

In the exhaust gas purification catalyst of one aspect of the present disclosure, the catalyst coat layer of the first catalyst can have a two-layer structure. If the catalyst coat layer of the first catalyst is composed of two or more layers, each catalyst coat layer of the first catalyst may have the same composition as or a different composition from the adjacent catalyst coat layer. If the catalyst coat layer of the first catalyst is composed of two or more layers, the catalyst coat layer composed of two or more layers can be classified into an uppermost catalyst coating and a lower-layer catalyst coating present in the lower layer with respect to the uppermost-layer catalyst coating. If the first catalyst includes two or more catalyst coat layers, one layer may be formed from the side where the exhaust gas flows in on the substrate, and the other layer may be formed from the side where the exhaust gas flows out on the substrate.

The width of each catalyst coat layer of the first catalyst is not limited, but is usually in a range of 20% or more and 100% or less of the overall length of the substrate in the first catalyst, and in a range of 30% or more and 80% or less of the overall length of the substrate in the first catalyst in one embodiment. Each catalyst coat layer of the first catalyst may be formed from the front side (Fr side), or from the rear side (Rr side), with respect to the exhaust gas flow direction. In the exhaust gas purification catalyst of one aspect of the present disclosure, the first catalyst includes two catalyst coat layers. One catalyst coat layer is formed from the Fr side, and the other catalyst coat layer is formed from the Rr side.

By the width of the catalyst coat layers of the first catalyst being within the range, the aggregation between catalyst metals due to a too short width, for example, the aggregation of Pd and Pt due to the increase in density of Pd and Pt, can be suppressed, and the frequency of contact of Pd and Pt with harmful components in the exhaust gas, such as HC, can be improved. Accordingly, the exhaust gas purification performance can be improved.

### (Fr-Side Coat Layer of Second Catalyst)

The width of the Fr-side coat layer is not limited, but is usually in a range of 10% or more and 100% or less of the overall length of the substrate in the second catalyst, and in a range of 60% or more and 90% or less of the overall length of the substrate in the second catalyst in one embodiment. The Fr-side coat layer is formed from the front side (Fr side) with respect to the exhaust gas flow direction.

### (Rr-Side Coat Layer of Second Catalyst)

The width of the Rr-side coat layer is not limited, but is usually in a range of 10% or more and 100% or less of the overall length of the substrate in the second catalyst, and in a range of 60% or more and 90% or less of the overall length of the substrate in the second catalyst in one embodiment. The Rr-side coat layer is formed from the rear side (Rr side) with respect to the exhaust gas flow direction.

In one aspect of the present disclosure, the second catalyst consists only of the Fr-side coat layer and the Rr-side coat layer. In one aspect of the present disclosure, the second catalyst further includes one or more catalyst coat layers, in addition to the Fr-side coat layer and the Rr-side coat layer.

### (Constituents of Catalyst Coat Layer)

Each catalyst coat layer, that is, the catalyst coat layer in the first catalyst, as well as the Fr-side coat layer, the Rr-side coat layer, and possibly further catalyst coat layers in the second catalyst, contains a noble metal that serves as a main catalyst and an OSC material.

Examples of the noble metal constituting catalyst particles specifically include at least one selected from the group consisting of platinum (Pt), palladium (Pd), rhodium (Rh), aurum (gold) (Au), argentum (silver) (Ag), iridium (Ir), and ruthenium (Ru). Among these, from the viewpoint of catalytic performance, at least one selected from the group consisting of Pt, Rh, Pd, Ir, and Ru is used in some embodiments, and at least one selected from the group consisting of Pt, Rh, and Pd is particularly used in some embodiments. If the catalyst coat layer of the first catalyst is composed of two or more layers, one noble metal may be used per catalyst coat layer.

The noble metal may be supported on the OSC material described in detail below and/or metal oxides other than the OSC material, such as aluminum oxide (Al₂O₃, alumina), zirconium oxide (ZrO₂, zirconia), silicon oxide (SiO₂, silica), yttrium oxide (Y₂O₃, yttria), and neodymium oxide (Nd₂O₃), and a mixture or composite oxide of them. The support amount of the noble metal is not particularly limited, and it is only necessary to appropriately support the necessary amount according to the intended design, and the like. The content of the noble metal is, in terms of metal equivalent, usually in a range of 0.01 g/L-zone or more and 10 g/L-zone or less per unit volume of the substrate to which the catalyst coat layer is applied, and in a range of 0.01 g/L-zone or more and 5 g/L-zone or less per unit volume of the substrate to which the catalyst coat layer is applied in one embodiment. If the support amount of the noble metal is too small, catalytic activity tends to be insufficient, whereas if it is too large, the cost tends to rise as catalytic activity becomes saturated. However, such problems do not arise in the above ranges.

For example, if the catalyst coat layer of the first catalyst is composed of two or more layers, the uppermost catalyst coat layer of the two or more catalyst coat layers formed on the substrate is highly exposed to high stress of high-temperature and high-concentration gas and poisonous substances, such as sulfur (S) and hydrocarbons (HC), compared to the lower catalyst coat layer. For this reason, a noble metal whose catalytic activity is not easily damaged by stress or poisoning may be used in the uppermost catalyst coat layer to make the catalyst durable against them. Such noble metals include, for example, Rh. In addition, examples of the noble metal that is relatively vulnerable to stress or poisoning and may be used in layers other than the uppermost catalyst coating include, for example, Pd and Pt.

In one aspect of the present disclosure, the Fr-side coat layer is formed under the Rr-side coat layer. In this aspect, as described in the above description of the properties of the noble metal, in some embodiments, the Fr-side coat layer contains Pd and/or Pt, especially Pt, while the Rr-side coat layer contains Rh in some embodiments. In one aspect of the present disclosure, the Fr-side coat layer is formed on the Rr-side coat layer. In this aspect, as described in the above description of the properties of the noble metal, in some embodiments, the Rr-side coat layer contains Pd and/or Pt, while the Fr-side coat layer contains Rh in some embodiments.

The OSC material is not limited as long as it has OSC performance. Examples of the OSC material include, for example, ceria, alumina-ceria-zirconia composite oxide (ACZ), ceria-zirconia composite oxide (CZ), and combinations of two or more of them. For the composition (blending amount) of each oxide in the OSC material, a composition known in the relevant technical field can be used.

The amount of coating per layer of each catalyst coat layer is usually in a range of 20 g/L or more and 300 g/L or less per unit volume of the substrate, in a range of 50 g/L or more and 250 g/L or less per unit volume of the substrate in one embodiment, and in a range of 50 g/L or more and 200 g/L or less per unit volume of the substrate in one embodiment. If the amount of coating is too small, the catalytic activity performance of the catalyst particles cannot be sufficiently obtained, and therefore, sufficient catalytic performance, such as NOx conversion performance, cannot be obtained. On the other hand, if the amount of coating is too large, increased pressure loss and poor fuel economy are caused. However, the above ranges can maintain a balance between pressure loss, catalytic performance, and durability.

For the thickness per layer of each catalyst coat layer, the average thickness is usually in a range of 5 μm or more and 160 μm or less, in a range of 30 μm or more and 96 μm or less in one embodiment, and in a range of 32 μm or more and 92 μm or less in one embodiment. If the catalyst coat layer is too thin, sufficient catalytic performance cannot be obtained, whereas if it is too thick, the pressure loss when exhaust gases and the like pass through becomes large, and sufficient catalytic performance, such as NOx conversion performance, cannot be obtained. However, the above ranges can maintain a balance between pressure loss, catalytic performance, and durability. Here, the “thickness” of the catalyst coat layer means the length in a direction perpendicular to the center of a flat portion of the substrate of the catalyst coat layer, that is, the shortest distance between the surface of the catalyst coat layer and the substrate surface (the interface with respect to the lower-layer catalyst coating if a lower-layer catalyst coating is present). The average thickness of the catalyst coat layer can be calculated, for example, by observing the catalyst coat layer using a scanning electron microscope (SEM) or an optical microscope, measuring the thickness of any 10 or more sections, and then calculating the average value of the thicknesses.

Each catalyst coat layer is constituted primarily of a noble metal and an OSC material, and may further contain other components to the extent that the effect of the present disclosure is not impaired. Other components include other metal oxides and additives used in catalyst coat layers for this type of application, and specifically include at least one of alkali metals, such as potassium (K), sodium (Na), lithium (Li), and cesium (Cs), alkaline-earth metals, such as barium (Ba), calcium (Ca), and strontium (Sr), rare earth elements, such as lanthanum (La), yttrium (Y), and cerium (Ce), transition metals, such as iron (Fe), and the like.

### (Method for Manufacturing First Catalyst)

In the exhaust gas purification catalyst of one aspect of the present disclosure, a method for manufacturing the first catalyst includes forming a catalyst coating of the first catalyst using a catalyst slurry containing noble metal particles having catalytic activity and an OSC material. If the catalyst coat layer of the first catalyst is composed of two or more layers, the first catalyst can be formed according to a conventionally known method.

A noble metal raw material for preparing the noble metal particles is not particularly limited, and examples include, for example, a solution with salts (for example, acetate, carbonate, nitrate, ammonium salt, citrate, dinitrodiammine salt, and the like) of a noble metal (such as Pt, Rh, Pd, or Ru, or its compounds) or their complexes (such as tetraammine complex) dissolved in solvents, such as water and alcohol. Also, the amount of the noble metal is determined based on the content of the noble metal in the first catalyst or the second catalyst. When platinum is used as a noble metal, a platinum salt is not particularly limited, and examples include, for example, acetate, carbonate, nitrate, ammonium salt, citrate, dinitrodiammine salt, and the like of platinum (Pt) or their complexes. Among these, a dinitrodiammine salt is used in some embodiments, from the viewpoint of its ease of being supported and high dispersion. When palladium is used as a noble metal, a palladium salt is not particularly limited, and examples include, for example, acetate, carbonate, nitrate, ammonium salt, citrate, dinitrodiammine salt, and the like of palladium (Pd) or solutions of their complexes. Among these, nitrate and a dinitrodiammine salt are used in some embodiments, from the viewpoint of their ease of being supported and high dispersion. Furthermore, the solvent is not particularly limited, and examples include, for example, solvents capable of dissolving substances in ionic form, such as water (pure water, such as ion-exchanged water or distilled water, in some embodiments).

The method for preparing the catalyst slurry is not particularly limited. It is only necessary to mix the OSC material and the noble metal raw material with a known binder and the like, as required, and a known method can be adopted as appropriate. The conditions for such mixing are not particularly limited. For example, in some embodiments, the stirring speed is in a range of 100 rpm or more and 400 rpm or less, with a processing time of 30 minutes or more, and it is only necessary to be able to uniformly disperse and mix the components in the catalyst slurry. In addition, the order of mixing is not particularly limited. The processing conditions are not particularly limited and are appropriately selected according to the design and the like of the target exhaust gas purification catalyst.

The method for applying the catalyst slurry is not particularly limited, and a known method can be adopted as appropriate. Specific examples include a method in which a honeycomb-shaped substrate is immersed in the catalyst slurry to apply the catalyst slurry (immersion method), a wash coat method, a method in which the catalyst slurry is injected under pressure, and the like.

In the manufacturing method of the first catalyst of the present disclosure, by applying the catalyst slurry to the substrate and then heating it, the solvent and the like contained in the slurry are evaporated. Heating is typically performed by firing the substrate to which the catalyst slurry is applied. The firing is performed at a temperature usually in a range of 300° C or more and 800° C or less, and in a range of 400° C or more and 700° C or less in one embodiment. If the firing temperature is too low, for example, noble metal particles are not formed, whereas if it is too high, noble metal particles tend to be sintered. However, in the above ranges, such problems do not arise. It is difficult to determine the firing period because it varies depending on the firing temperature. However, the firing period is usually 20 minutes or more, and in a range of 30 minutes or more and two hours or less in one embodiment. Furthermore, the atmosphere during the firing is not particularly limited, but it is in the atmospheric air or in an inert gas, such as nitrogen (N₂).

In the exhaust gas purification catalyst of the present disclosure, when the first catalyst having two or more catalyst coat layers with different compositions is manufactured, it can be prepared as follows. A catalyst coating is formed on the substrate by applying a catalyst slurry to the substrate and heating it. Then, another catalyst slurry with a different composition, that is, different amounts and types of a metal oxide and a noble metal, is applied again over the catalyst coating and heated. Applying a catalyst slurry and heating it are repeated.

As one aspect of the exhaust gas purification catalyst of the present disclosure, the catalyst coat layer of the first catalyst has two layers and can be prepared as follows. After forming a lower-layer catalyst coating layer using a catalyst slurry containing Pd as noble metal particles and an OSC material, an uppermost catalyst coating is formed on the lower catalyst coat layer using a catalyst slurry containing Rh as noble metal particles and an OSC material.

### (Method for Manufacturing Second Catalyst)

The second catalyst in the exhaust gas purification catalyst of the present disclosure can be prepared similarly to the manufacturing method of the first catalyst, provided that the Fr-side coat layer is formed from an end surface that is on the Fr side with respect to the exhaust gas flow direction of the substrate, and the Rr-side coat layer is formed from an end surface that is on the Rr side with respect to the exhaust gas flow direction of the substrate, in the manufacturing method of the first catalyst described above. The order of forming the Fr-side coat layer and the Rr-side coat layer is not limited. For example, a second catalyst with the Rr-side coat layer formed on the Fr-side coat layer may be prepared by forming the Rr-side coat layer after forming the Fr-side coat layer. Alternatively, a second catalyst with the Fr-side coat layer formed on the Rr-side coat layer may be prepared by forming the Fr-side coat layer after forming the Rr-side coat layer.

In one aspect of the present disclosure, the first catalyst is connected to the second catalyst by a technique known in the relevant technical field to form an exhaust gas purification catalyst. The connection method is not limited. The exhaust gas purification catalyst of one aspect of the present disclosure consists of two catalysts with the first catalyst and the second catalyst combined, and, for example, it can be applied to a tandem-type exhaust gas purification catalyst.

As one aspect of the exhaust gas purification catalyst of the present disclosure, in a tandem-type exhaust gas purification catalyst, the first catalyst can be applied as a catalyst in the front stage with respect to the exhaust gas flow direction, and the second catalyst can be applied as a catalyst in the rear stage with respect to the exhaust gas flow direction.

In the tandem-type exhaust gas purification catalyst, by the front-stage and rear-stage catalysts functioning as the first catalyst and the second catalyst, respectively, in the resulting exhaust gas purification catalyst, excellent purification performance can be ensured even after durability testing.

The exhaust gas purification catalyst of the present disclosure is used in a method for purifying exhaust gas by contacting the exhaust gas discharged from an internal combustion engine. The method of contacting exhaust gas with the exhaust gas purification catalyst is not particularly limited, and a known method can be adopted as appropriate. For example, a method of contacting the exhaust gas from the internal combustion engine with the exhaust gas purification catalyst by placing the exhaust gas purification catalyst according to the above present disclosure in an exhaust gas pipe through which the gas discharged from the internal combustion engine flows may be adopted.

### (Aspect of Use of Exhaust Gas Purification Catalyst of the Present Disclosure)

The exhaust gas purification catalyst of the present disclosure may be used alone or in combination with other catalysts. Other such catalysts are not particularly limited, and known catalysts may be appropriately used. Examples in the case of automotive exhaust gas purification catalysts include oxidation catalysts, NOx reduction catalysts, NOx storage-reduction type catalysts (NSR catalysts), lean NOx trap catalysts (LNT catalysts), NOx selective reduction catalysts (second catalyst R catalysts), and the like.

### Examples

The following describes the present disclosure in more detail using examples, but the present disclosure is not limited to these examples.

### 1. Raw Materials Used

Material 1 (Al₂O₃): Carrier-cum-coat retaining material
La₂O₃: 1% by weight, Al₂O₃: 99% by weight
Material 2 (ACZ (i)): Pd carrier-cum-OSC material
Al₂O₃: 30% by weight, CeO₂: 20% by weight, ZrO₂: 40% by weight, Y₂O₃: 5% by weight, La₂O₃: 5% by weight, specific surface area (SSA): 120 m²/g
Material 3 (ACZ (ii)): Pd carrier-cum-OSC material
Al₂O₃: 30% by weight, CeO₂: 20% by weight, ZrO₂: 40% by weight, Y₂O₃: 5% by weight, La₂O₃: 5% by weight, SSA: 20 m²/g
Material 4 (AZ): Rh carrier
Al₂O₃: 30% by weight, ZrO₂: 60% by weight, La₂O₃: 5% by weight, Y₂O₃: 5% by weight
Material 5 (fluorite type ZC (i)): OSC material
CeO₂: 20% by weight, ZrO₂: 70% by weight, La₂O₃: 5% by weight, Y₂O₃: 5% by weight, SSA: 80 m²/g
Material 6 (fluorite type ZC (ii)): OSC material
CeO₂: 20% by weight, ZrO₂: 70% by weight, La₂O₃: 5% by weight, Y₂O₃: 5% by weight, SSA: 50 m²/g
Material 7 (fluorite type ZC (iii)): OSC material
CeO₂: 20% by weight, ZrO₂: 70% by weight, La₂O₃: 5% by weight, Y₂O₃: 5% by weight, SSA: 40 m²/g
Material 8 (fluorite type ZC (iv)): OSC material
CeO₂: 20% by weight, ZrO₂: 70% by weight, La₂O₃: 5% by weight, Y₂O₃: 5% by weight, SSA: 30 m²/g
Material 9 (pyrochlore type CZ) (for the preparation method, refer to JP 2018-038999 A and the like): OSC material
CeO₂: 51.7% by weight, ZrO₂: 45.6% by weight, Pr₆O: 1.7% by weight, SSA: 2 m²/g
Material 10 (barium sulfate): Ba
Material 11 (palladium nitrate, 8.2% by weight): Pd
Material 12 (rhodium nitrate, 2.75% by weight): Rh
Material 13 (platinum nitrate, 8.4% by weight): Pt
Substrate for first catalyst
An 875 cc cordierite honeycomb substrate (600 cells per square inch, hexagonal, 2 mil wall thickness) was used.
Substrate for second catalyst
A 1083 cc cordierite honeycomb substrate (400 cells per square inch, square, 4 mil wall thickness) was used.

### 2. Catalyst Preparation Method

### (First Catalyst (i))

First, a suspended slurry 1 was prepared by adding palladium nitrate (material 11), ACZ (material 2), Al₂O₃ (material 1), barium sulfate (material 10), and an Al₂O₃-based binder to distilled water while stirring. Next, the prepared slurry 1 was poured onto a substrate, and the material was coated on a wall surface of the substrate by blowing off the unnecessary part with a blower. At that time, a coat layer was prepared such that the coating material contained 2.5 g/L-zone of the material 11 as Pd, 75 g/L-zone of the material 2, 25 g/L-zone of the material 1, and 13 g/L-zone of the material 10, with respect to the substrate volume. The coating width was adjusted to 30% of the substrate length. Finally, a first coat layer was prepared by firing the coat layer at 500° C for two hours in an electric furnace after removing the water content in a dryer kept at 120° C for two hours.

Next, Rh/AZ was prepared by adding rhodium nitrate (material 12) and AZ (material 4) to distilled water while stirring, and then drying and firing them. Afterward, a suspended slurry 2 was prepared by adding Rh/AZ, fluorite type ZC (i) (material 5), pyrochlore type CZ (material 9), Al₂O₃ (material 1), and an Al₂O₃-based binder to distilled water while stirring. This was poured onto the substrate to which the slurry 1 was applied from an end surface opposite to the end surface to which the slurry 1 was applied, and the material was coated on the wall surface of the substrate by blowing off the unnecessary part with a blower. At that time, a coat layer was prepared such that the coating material contained 0.3 g/L-zone of the material 12 as Rh, 40 g/L-zone of the material 1, 40 g/L-zone of the material 4, 75 g/L-zone of the material 5, and 25 g/L-zone of the material 9, with respect to the substrate volume. The coating width was adjusted to 80%. Finally, a second coat layer was prepared by firing the coat layer at 500° C for two hours in an electric furnace after removing the water content in a dryer kept at 120° C for two hours. As a result, the total surface area of the OSC material contained in the first catalyst (i) (SAfinrst catalyst (i)) was 6598 m²/piece.

(First Catalyst (ii))

A first catalyst (ii) was prepared similarly to the preparation method of the first catalyst (i), except that the material 3 was used instead of the material 2, further in the Rh layer, the content of the material 5 was changed to 50 g/L-zone, and the content of the material 9 was changed to 35 g/L-zone, in the preparation method of the first catalyst (i). As a result, the total surface area of the OSC material contained in the first catalyst (ii) (SA_{first catalyst (ii)}) was 3243 m²/piece.

### (Second Catalyst (i))

First, a suspended slurry 1 was prepared by adding platinum nitrate (material 13), fluorite type ZC (i) (material 5), Al₂O₃ (material 1), barium sulfate (material 10), and an Al₂O₃-based binder to distilled water while stirring. Next, the prepared slurry 1 was poured onto a substrate, and the material was coated on a wall surface of the substrate by blowing off the unnecessary part with a blower. At that time, a coat layer was prepared such that the coating material contained 1.0 g/L-zone of the material 13 as Pt, 30 g/L-zone of the material 1, 50 g/L-zone of the material 5, and 3 g/L-zone of the material 10, with respect to the substrate volume. The coating width was adjusted to 40%. Finally, a first coat layer was prepared by firing the coat layer at 500° C for two hours in an electric furnace after removing the water content in a dryer kept at 120° C for two hours.

First, Rh/AZ was prepared by adding rhodium nitrate (material 12) and AZ (material 4) to distilled water while stirring, and then drying and firing them. Afterward, a suspended slurry 2 was prepared by adding Rh/AZ, fluorite type ZC (i) (material 5), pyrochlore type CZ (material 9), Al₂O₃ (material 1), and an Al₂O₃-based binder to distilled water while stirring. This was poured onto the substrate to which the slurry 1 was applied from an end surface opposite to the end surface to which the slurry 1 was applied, and the material was coated on the wall surface of the substrate by blowing off the unnecessary part with a blower. At that time, a coat layer was prepared such that the coating material contained 0.3 g/L-zone of Rh, 40 g/L-zone of the material 1, 60 g/L-zone of the material 4, 60 g/L-zone of the material 5, and 10 g/L-zone of the material 9, with respect to the substrate volume. The coating width was adjusted to 80% of the substrate length. Finally, a second coat layer was prepared by firing the coat layer at 500° C for two hours in an electric furnace after removing the water content in a dryer kept at 120° C for two hours. As a result, the total surface area of the OSC material in the first layer (Fr-side coat layer) contained in the second catalyst (i) (SA_{Fr-side coat layer}) was 3466 m²/piece (layer). Furthermore, the total surface area of the OSC material in the second layer (Rr-side coat layer) contained in the second catalyst (i) (SA_{Rr-side coat layer}) was 4176 m²/piece.

(Second Catalyst (ii))

A second catalyst (ii) was prepared similarly to the preparation method of the second catalyst (i), except that the material 6 was used instead of the material 5 in the second layer in the second catalyst (i). As a result, the total surface area of the OSC material in the second layer contained in the second catalyst (ii) (SA_{Rr-side coat layer}) was 2617 m²/piece.

(Second Catalyst (iii))

A second catalyst (iii) was prepared similarly to the preparation method of the second catalyst (i), except that the material 7 was used instead of the material 5 in the second layer in the second catalyst (i). As a result, the total surface area of the OSC material in the second layer contained in the second catalyst (iii) (SA_{Rr-side coat layer}) was 2097 m²/piece.

(Second Catalyst (iv))

A second catalyst (iv) was prepared similarly to the preparation method of the second catalyst (i), except that the material 8 was used instead of the material 5 in the second layer in the second catalyst (i). As a result, the total surface area of the OSC material in the second layer contained in the second catalyst (iv) (SA_{Rr-side coat layer}) was 1577 m²/piece.

### (Second Catalyst (v))

A second catalyst (v) was prepared similarly to the preparation method of the second catalyst (i), except that the material 8 was used instead of the material 5 in the first layer in the second catalyst (i). As a result, the total surface area of the OSC material in the first layer contained in the second catalyst (v) (SA_{Fr-side coat layer}) was 1300 m²/piece.

(Second Catalyst (vi))

A second catalyst (vi) was prepared similarly to the preparation method of the second catalyst (v), except that the material 8 was used instead of the material 5 in the second layer in the second catalyst (v). As a result, the total surface area of the OSC material in the second layer contained in the second catalyst (vi) (SA_{Rr-side coat layer}) was 1577 m²/piece.

(Second Catalyst (vii))

A second catalyst (vii) was prepared similarly to the preparation method of the second catalyst (vi), except that the content of the material 8 of the second layer was changed to 35 g/L-zone, and the content of the material 9 was changed to 20 g/L-zone, in the second catalyst (vi). As a result, the total surface area of the OSC material in the second layer contained in the second catalyst (vii) (SA_{Rr-side coat layer}) was 944 m²/piece.

(Second Catalyst (viii))

A second catalyst (viii) was prepared similarly to the preparation method of the second catalyst (vii), except that the material 8 of the first layer was changed to the material 5 in the second catalyst (vii). As a result, the total surface area of the OSC material in the first layer contained in the second catalyst (viii) (SA_{Fr-side coat layer}) was 3466 m²/piece.

Table 1 shows the list of the configurations of the first catalyst and the second catalyst and the SA of the OSC material in each catalyst or layer.

### [Table 1]

### Table 1. List of Configurations of First Catalyst and Second Catalyst and Total Surface Area (SA) of OSC Material in Each Catalyst or Layer

TABLE 1

| | First layer (Fr-Pd Layer)_30% | | | | | | | |
|---|---|---|---|---|---|---|---|---|
| | Material | Material 2 | Material | Material | Material | Material | | |
| | 1 | (ACZ) | (ACZ) | 3 | 11 | 10 | | |
| | (Al₂O₃) | 120 m²/g | 60 m²/g | (ACZ) | (Pd) | (Ba) | | |
| First Catalyst (i) | 25 | 75 | 0 | 0 | 2.5 | 13 | | |
| First Catalyst (ii) | 25 | 0 | 0 | 75 | 2.5 | 13 | | |
| | Second Layer (Rr-Rh Layer)_80% | | | | | | | |
| | Material | Material | Material 5 | Material 9 | Material | | | |
| | 4 | 1 | (Fluorite Type | (Pyrochlore | 12 | SA of OSC | | |
| | (AZ) | (Al₂O₃) | ZC) 80 m²/g | Type ZC) | (Rh) | material | | |
| First Catalyst (i) | 40 | 40 | 75 | 25 | 0.3 | 6598 | | |
| First Catalyst (ii) | 40 | 40 | 50 | 35 | 0.3 | 3243 | | |
| | First layer (Fr-Pt Layer)_80% | | | | | Second Layer (Rr-Rh Layer)_80% | | |
| | | Material 5 | Material 8 | | | | | Material 5 |
| | Material | (Fluorite | (Fluorite | Material | Material | Material | Material | (Fluorite |
| | 1 | Type ZC) | Type ZC) | 13 | 10 | 4 | 1 | Type ZC) |
| | (Al₂O₃) | 80 m²/g | 30 m²/g | (Pt) | (Ba) | (AZ) | (AD) | 80 m²/g |
| Second | 30 | 50 | 0 | 1 | 3 | 60 | 40 | 60 |
| Catalyst (i) | | | | | | | | |
| Second | 30 | 50 | 0 | 1 | 3 | 60 | 40 | 0 |
| Catalyst (ii) | | | | | | | | |
| Second | 30 | 50 | 0 | 1 | 3 | 60 | 40 | 0 |
| Catalyst (iii) | | | | | | | | |
| Second | 30 | 50 | 0 | 1 | 3 | 60 | 40 | 0 |
| Catalyst (iv) | | | | | | | | |
| Second | 30 | 0 | 50 | 1 | 3 | 60 | 40 | 60 |
| Catalyst (v) | | | | | | | | |
| Second | 30 | 0 | 50 | 1 | 3 | 60 | 40 | 0 |
| Catalyst (vi) | | | | | | | | |
| Second | 30 | 0 | 50 | 1 | 3 | 60 | 40 | 0 |
| Catalyst (vi) | | | | | | | | |
| Second | 30 | 50 | 0 | 1 | 3 | 60 | 40 | 0 |
| Catalyst (viii) | | | | | | | | |

| | | | | | | SA of OSC | SA of OSC |
|---|---|---|---|---|---|---|---|
| | Second Layer (Rr-Rh Layer)_80% | | | | | Material | Material |
| | Material 6 | Material 7 | Material 8 | | | in First | in Second |
| | (Fluorite | (Fluorite | (Fluorite | Material 9 | Material | layer | Layer |
| | Type ZC) | Type ZC) | Type ZC) | (Pyrochlore | 12 | (Fr-Pt | (Rr-Rh |
| | 50 m²/g | 40 m²/g | 30 m²/g | Type ZC) | (Rh) | Layer) | Layer) |
| Second | 0 | 0 | 0 | 10 | 0.3 | 3466 | 4176 |
| Catalyst (i) | | | | | | | |
| Second | 60 | 0 | 0 | 10 | 0.3 | 3466 | 2617 |
| Catalyst (ii) | | | | | | | |
| Second | 0 | 60 | 0 | 10 | 0.3 | 3466 | 2097 |
| Catalyst (iii) | | | | | | | |
| Second | 0 | 0 | 60 | 10 | 0.3 | 3466 | 1577 |
| Catalyst (iv) | | | | | | | |
| Second | 0 | 0 | 0 | 10 | 0.3 | 1300 | 4176 |
| Catalyst (v) | | | | | | | |
| Second | 0 | 0 | 60 | 10 | 0.3 | 1300 | 1577 |
| Catalyst (vi) | | | | | | | |
| Second | 0 | 0 | 35 | 20 | 0.3 | 1300 | 944 |
| Catalyst (vi) | | | | | | | |
| Second | 0 | 0 | 35 | 20 | 0.3 | 3466 | 944 |
| Catalyst (viii) | | | | | | | |

The values of the coatings indicate the coating width with respect to the substrate length. (g/L-zone)

Furthermore, the prepared first catalyst and the second catalyst were combined to manufacture exhaust gas purification catalysts of examples and comparative examples. Table 2 shows the types of the first catalyst and the second catalyst, and the total surface area of each catalyst or layer in the exhaust gas purification catalysts of the examples and the comparative examples.

TABLE 2

| | | | SA of | SA of | SA of |
|---|---|---|---|---|---|
| | | | First | Fr-Side | Rr-Side |
| | First | Second | Catalyst | Coat Layer | Coat Layer |
| | Catalyst | Catalyst | m²/piece | m²/piece | m²/piece |
| Example 1 | (i) | (ii) | 6598 | 3466 | 2617 |
| Example 2 | (i) | (iii) | 6598 | 3466 | 2097 |
| Example 3 | (i) | (iv) | 6598 | 3466 | 1577 |
| Example 4 | (i) | (vii) | 6598 | 1300 | 944 |
| Example 5 | (ii) | (vii) | 3243 | 1300 | 944 |
| Example 6 | (i) | (viii) | 6598 | 3466 | 944 |
| Comparative | (i) | (i) | 6598 | 3466 | 4176 |
| Example 1 | | | | | |
| Comparative | (i) | (v) | 6598 | 1300 | 4176 |
| Example 2 | | | | | |
| Comparative | (ii) | (ii) | 3243 | 3466 | 2617 |
| Example 3 | | | | | |
| Comparative | (ii) | (viii) | 3243 | 3466 | 944 |
| Example 4 | | | | | |
| Comparative | (ii) | (v) | 3243 | 1300 | 4176 |
| Example 5 | | | | | |

### 3. Durability Testing

Durability testing was performed on each prepared exhaust gas purification catalyst using an actual engine. Specifically, it was performed by installing each exhaust gas purification catalyst in the exhaust system of a V-6 engine, setting the bed temperature of the first catalyst to 1000° C, setting the bed temperature of the second catalyst to 950° C, and repeatedly flowing exhaust gases in stoichiometric and lean atmospheres for a certain period of time (a ratio of 10:1) over 50 hours.

### 4. Performance Evaluation

Performance evaluation was performed on each exhaust gas purification catalyst after 3. durability testing using an actual engine. Specifically, each exhaust gas purification catalyst was installed in the exhaust system of an L-4 engine, and the evaluation was performed under the following conditions.

### (NOx Conversion Rate During Continuation of Rich Condition)

The evaluation was performed at a NOx conversion rate 30 seconds after supplying exhaust gas Ga=35 g/s with an air-fuel ratio (A/F) of 14.1 at 500° C. The NOx conversion performance of the second catalyst was compared based on the amount of NOx discharged from the first catalyst.

### 5. Evaluation Results

Table 3 shows the NOx conversion rate of the second catalyst alone in each exhaust gas purification catalyst.

### [Table 3]

### Table 3. List of Evaluation Results

TABLE 3

| | NOx Conversion Rate (%) |
|---|---|
| | of Second Catalyst Alone |
| Example 1 | 79.2 |
| Example 2 | 81.5 |
| Example 3 | 82.9 |
| Example 4 | 73.3 |
| Example 5 | 70.1 |
| Example 6 | 81.0 |
| Comparative Example 1 | 65.0 |
| Comparative Example 2 | 61.4 |
| Comparative Example 3 | 58.5 |
| Comparative Example 4 | 54.4 |
| Comparative Example 5 | 51.9 |

From Table 3, it was found that in Examples 1 to 3 where the SA_{Rr-side coat layer} of the OSC material contained in the Rh layer (Rr-side coat layer) of the second catalyst fell below the SA_{Fr-side coat layer} of the OSC material contained in the Pt layer (Fr-side coat layer), the NOx conversion rate during the continuation of Rich condition improved compared to Comparative Example 1. This is presumed to result from lowering the SA of the OSC material that is prone to accumulation in the Rh layer, which is particularly susceptible to performance deterioration when unburned fuel components accumulate.

On the other hand, in Comparative Example 2 where the SA_{Fr-side coat layer} of the OSC material contained in the Pt layer was lowered, performance improvement could not be confirmed. It is assumed that it is important to lower the SA_{Rr-side coat layer} of the OSC material in the Rh layer (Rr-side coat layer) present on the Rr side of the second catalyst.

In a case where both the SA_{first catalyst} of the OSC material contained in the first catalyst and the SA_{second catalyst} of the OSC material contained in the second catalyst are lowered, the effect is reduced, but the performance is expected to improve.

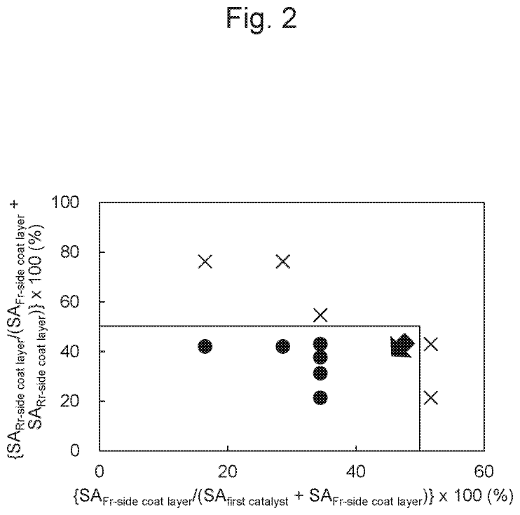

FIG. 2 illustrates the relationship between {SA_{Fr-side coat layer}/(SA_{first catalyst}+SA_{Fr-side coat layer})}×100 and {SA_{Rr-side coat layer}/(SA_{Fr-side coat layer}+SA_{Rr-side coat layer})}×100. In FIG. 2, the black circles indicate the examples, and the crosses indicate the comparative examples. From FIG. 2, it was found that when {SA_{Fr-side coat layer}/(SA_{First catalyst}+SA_{Fr-side coat layer})}×100 is 50 or less, and {SA_{Rr-side coat layer}/(SA_{Fr-side coat layer}+SA_{Rr-side coat layer})}×100 is 50 or less, in the resulting exhaust gas purification catalyst, more excellent purification performance can be ensured even after durability testing.

All publications, patents and patent applications cited in the present description are herein incorporated by reference as they are.

What is claimed is:

1. An exhaust gas purification catalyst comprising
two catalysts with a first catalyst and a second catalyst combined, the second catalyst being arranged rearward of the first catalyst with respect to an exhaust gas flow direction,
wherein the second catalyst comprises an Fr-side coat layer in a front stage and an Rr-side coat layer in a rear stage, with respect to the exhaust gas flow direction,
wherein the first catalyst, the Fr-side coat layer, and the Rr-side coat layer comprise an OSC material,
wherein a total surface area of the OSC material comprised in the first catalyst (SA_{first catalyst}) and a total surface area of the OSC material comprised in the second catalyst (SA_{second catalyst}) satisfy
SA_{first catalyst}>SA_{second catalyst}, and
wherein a total surface area of the OSC material comprised in the Fr-side coat layer (SA_{Fr-side coat layer}) and a total surface area of the OSC material comprised in the Rr-side coat layer (SA_{Rr-side coat layer}) satisfy
SA_{Fr-side coat layer}>SA_{Rr-side coat layer}.

2. The exhaust gas purification catalyst according to claim 1, wherein
{SA_{Fr-side coat layer}/(SA_{first catalyst}+SA_{Fr-side coat layer})}×100 is 50 or less, and {SA_{Rr-side coat layer}/(SA_{Fr-side coat layer}+SA_{Rr-side coat layer})}×100 is 50 or less.

3. The exhaust gas purification catalyst according to claim 1, wherein
the Fr-side coat layer comprises Pt.

4. The exhaust gas purification catalyst according to claim 3, wherein
the Rr-side coat layer comprises Rh.
